(19) United States
(12) Patent Application Publication
(10) Pub. No.: US 2008/0200073 A1
(43) Pub. Date: Aug. 21, 2008

(54) ENCODING DEVICE FOR CONNECTORS

(76) Inventors: Alexandre Mermaz, Paris (FR); Jean-Merri de Vanssay, Paris (FR)

Correspondence Address: HAYES SOLOWAY P.C., 3450 E. SUNRISE DRIVE, SUITE 140, TUCSON, AZ, 85718, US

(21) Appl. No.: 12/019,545

(22) Filed: Jan. 24, 2008

(30) Foreign Application Priority Data
Feb. 15, 2007 (DE) 20 2007 002 248.4

(51) Int. Cl. H01R 13/10

(52) U.S. Cl. 439/682

(57) ABSTRACT

In order to realize a non-interchangeable mating of two connectors (1, 2), an encoding is provided on the mating side which is realized in the form of laminar encoding elements (20) that can be inserted into a slot (12) in the connector body (10) of the connectors.

In this case, an encoding element (20, 20′) that features mutually engaging structures (22, 22) for realizing an encodable mating is inserted into each of the connectors (1, 2).

### BACKGROUND OF THE INVENTION

1. Field of the Invention

The invention pertains to an encoding device in a connector housing with electric contacts in order to realize a non-interchangeable mating of a two-part plug-type connection.

An encoding device of this type is required for preventing an incorrect mating within a system of identical connectors.

2. Description of the Related Art

DE 298 23 719 U1 discloses an encoding device for two complementary connectors, one of which is provided with at least one first encoding element and the other one of which is provided with at least one complementary second encoding element, wherein at least one of the connectors comprises a housing with a slip-on coupling ring, on which at least one of the encoding elements is arranged.

The disadvantage of known encoding devices can be seen in that they are retrospectively designed for the corresponding connector type and therefore usually represent supplementary solutions.

### SUMMARY OF THE INVENTION

The invention is based on the objective of ensuring the simple, non-interchangeable and codable mating of a plug-type connection between hybrid connectors to be mated which features power contacts as well as signaling contacts.

This objective is attained in that a slot is provided in each of the connector bodies on the mating side, wherein an encoding element of laminar design is inserted into said slot, and in that additional openings for electric contacts are arranged to both sides of the slot.

The advantages attained with the invention can be seen, in particular, in that an essentially arbitrary number of encoding structures for mutually matible encoding elements inserted into the connector body of two connectors to be mated can be realized with a relatively simple design that features straight, vertical, horizontal, oblique and curved lines.

For this purpose, the connector body accommodating the electric contacts is provided with a slot on the mating side, wherein the encoding elements of laminar design are inserted and engaged in said slots. In this case, the outer edges of the encoding elements preferably abut one another in a precisely fitted fashion during the mating process.

Electric contacts arranged above and underneath the slot are separated in accordance with signaling contacts and current/voltage contacts.

The increased distance with the additional air gap contributes to an advantageous signal separation in this case.

The slots are only insignificantly larger than the disk-shaped encoding elements and provided with passageways, through which snap-in hooks are guided which are molded onto the encoding elements and can be engaged on retaining edges on the cable connection side of the respective connector body.

In this case, engaged encoding elements can also be removed again from the slots or exchanged.

The protection of the contacts and the encoding structures of the encoding elements, which protrude from the connector body, is realized in the form of a correspondingly designed metallic shielding sleeve that surrounds the connector body.

In this case, a V-shaped polarization moulded into the shielding sleeve initially ensures a correct mating position of both connectors during the mating process while the complementary encoding elements ensure that exactly these two connectors can be correctly mated if a multitude of possible plug-type connections can be realized.

### BRIEF DESCRIPTION OF THE DRAWINGS

One embodiment of the invention is illustrated in the figures and described in greater detail below. The figures show:

FIG. 1 is a connector in the form of a side view;

FIG. 2 is a connector realized in the form of a flanged housing;

FIG. 3 is a section through the connector in the flanged housing;

FIG. 4 is a section through a mated connection between the two connectors shown in FIG. 1 and FIG. 2, and

FIG. 5 are several variations of encoding elements.

### DESCRIPTION OF THE PREFERRED EMBODIMENTS

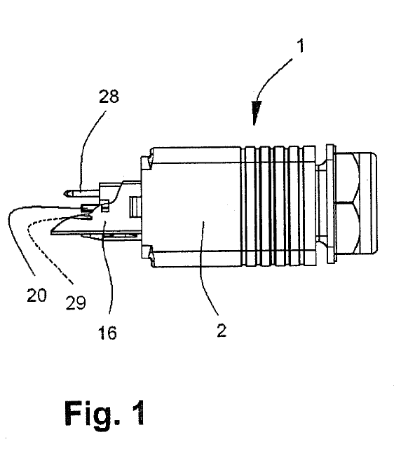

FIG. 1 shows a side view of a connector 1 that is realized in accordance with the so-called push-pull principle.

In this case, part of a shielding sleeve 16 that surrounds the electric contacts 28, 29 is illustrated in a sectioned fashion such that the tip of an inventive encoding element 20 is still visible. The signaling contact 29 is not visible in this figure.

The shielding sleeve 16 is arranged on a connector body 10 that accommodates the electric contacts within a displaceable outer sleeve 2.

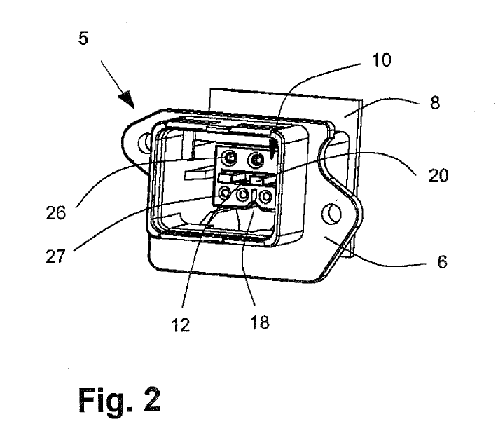

FIG. 2 shows an isometric representation of a mating connector 5 that is realized complementary to the connector 1 and the connector body 10 of which is arranged in a flanged housing 6.

Three adjacently positioned electric contacts 28 for a current/voltage transmission, as well as four additional signaling contacts 29 that are separated from one another by a larger average distance in a paired fashion, are illustrated in the connector body 10. The contacts are arranged within the openings 28′ and 29′ in the connector body 10, 10′.

A slot 12 is provided between the differently designed electric contacts on the mating side, wherein this slot is provided for accommodating a laminar encoding element 20.

The rectangular insulating connector body 10 is surrounded by a shielding sleeve 16, the seam of which extends in a V-shaped central groove 18 between the pairs of signaling contacts 29.

In this case, the groove is provided as a polarization for ensuring the correct mating of the two connectors 1, 5.

On the rear side, the electric contacts are connected to a circuit board 8. The encoding element 20 may have different geometrical shapes on its mating side. It would be possible to realize simple horizontal and vertical outer edges, as well as oblique and curve-like shapes.

It is merely important that the outer edges provided for the encoding abut one another in a precisely fitted fashion during the mating process so as to prevent the incorrect mating of two connectors 1 and 5.

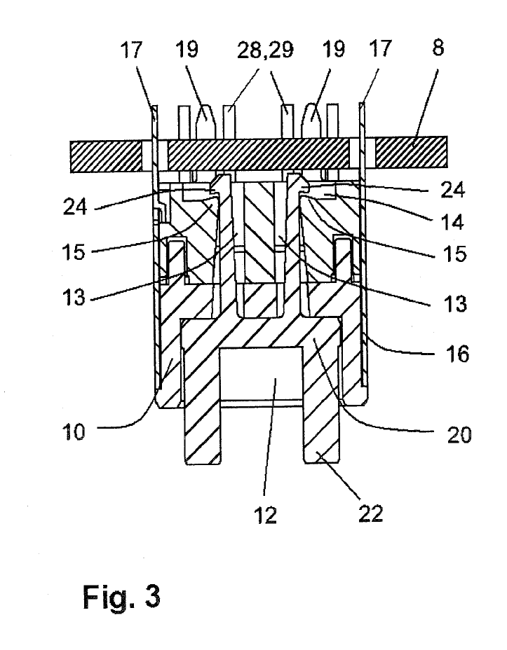

The sectional representation of the connector body 10 in FIG. 3 through the plane of the encoding element shows the position and the fixing of the encoding element 20 on the example of the connector 5 without the surrounding flanged housing 6.

The encoding element 20 is respectively inserted into the slot 12 on the mating side and engaged in the connector body 10 by means of snap-in hooks 24, wherein the encoding structures 22 partially protrude from the connector body.

For this purpose, one respective passageway 13 for the two snap-in hooks 24 in provided in the connector body 10 adjacent to the slot 12 for the encoding element 20.

On the connection side with the circuit board 8 and, in general, also on an electric cable to be connected to the connector 1, the ends of the passageways 13 respectively feature a retaining age 15, on which the snap-in box 24 of the encoding element 20 engage.

In this case, the retaining edges 15 are molded into a sunk recess 14 in the rear side of the connecting body in such a way that the snap-in hooks only protrude minimally over the end of the housing.

As long as the connector is not yet soldered to the circuit board 8, the encoding element 20 can be exchanged by pressing together the snap-in hooks 24 and pulling the encoding element out of the passageways 13 and the slot 12.

The rear side of the connector 2 that is usually realized with the flanged housing 6 is provided with a circuit board 8, to which the current/voltage contacts 28, the signaling contacts 29 and the connecting pins 17 of the shielding sleeve 16 are soldered.

In order to realize the mounting on the circuit board 8, the connector body 10 is provided with additional mounting pin 19 that are inserted into corresponding bores and hold the connector body together until it is soldered to the circuit board.

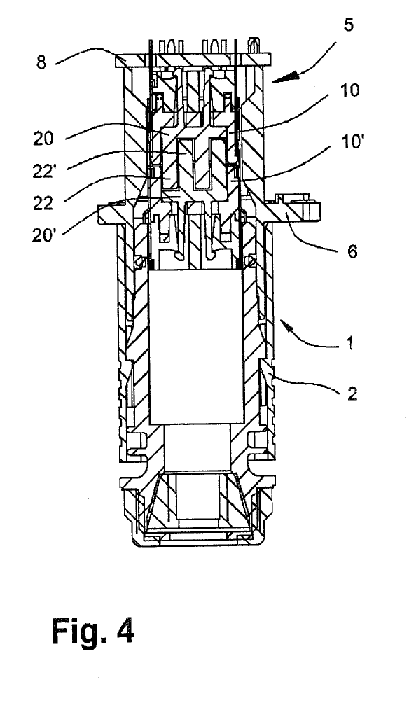

FIG. 4 shows the plug-type connection between the push-pull connector 1 and the mating connector 5 in the flanged housing 6, wherein this figure only shows the encoding of both encoding elements 20 and 20′ in the connector 2 and the connector 1.

This figure also shows that the encoding structures 22, 22′ protrude from each of the connector bodies 10, 10′ about centrally and into the respective oppositely arranged part.

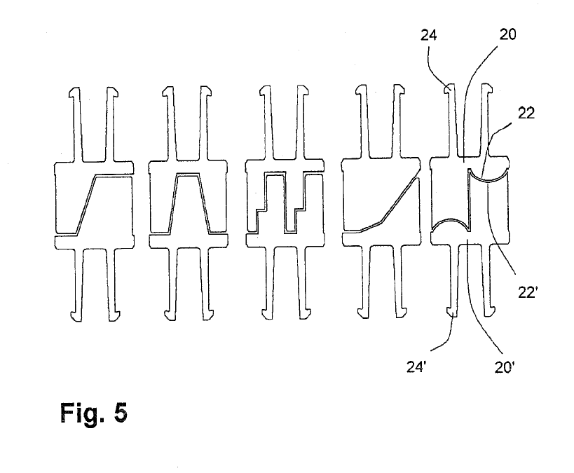

FIG. 5 shows a few laminar embodiments of encoding elements 20, 20′ that can be connected in a paired fashion and feature snap-in hooks 24, 24′, wherein said encoding elements may, in principle, have any number of matching encoding structures 22, 22′ with straight, vertical, horizontal, oblique and curved lines.

What is claimed is:

1. An encoding device in a connector body with electric contacts in order to realize a non-interchangeable mating of two connectors, wherein
a slot is provided in each of the connector bodies on the mating side, wherein an encoding element of laminar design is inserted into said slot, and in that additional openings for electric contacts are arranged to both sides of the slot.

2. The encoding device according to claim 1, wherein
the encoding element features snap-in hooks for holding the encoding element in the slot in the connector body.

3. The encoding device according to claim 1, wherein
two respective encoding elements feature complementary encoding structures on the mating side in order to ensure a non-interchangeable engagement of the connectors into one another.

4. The encoding device according to claim 3, wherein
the encoding structures feature, referred to the mating direction, vertical, horizontal, oblique and curve-shaped lines in different variations.

5. The encoding device according to claim wherein
the encoding structures of the encoding elements protrude from the slot on the mating side of the connector body.

6. The encoding device according to claim 1, wherein
the electric contacts are realized in the form of signaling contacts and in the form of current/voltage contacts.
